(19) United States
(12) Patent Application Publication
(10) Pub. No.: US 2025/0328022 A1
(43) Pub. Date: Oct. 23, 2025

(54) ARM INNER CHASSIS AND HINGE

(71) Applicant: Apple Inc., Cupertino, CA (US)

(72) Inventor: Depeng Wang, San Jose, CA (US)

(21) Appl. No.: 18/866,754

(22) PCT Filed: Jun. 13, 2023
(86) PCT No.: PCT/US2023/068385

§ 371 Date: Nov. 18, 2024

Related U.S. Application Data
(60) Provisional application No. 63/366,402, filed on Jun. 14, 2022.

(51) Int. Cl. G02B 27/01

(52) U.S. Cl. CPC G02B 27/0176

(57) ABSTRACT

An arm of a head-mountable display can include an arm tip, an arm hinge, and an enclosure. The enclosure can include a first surface, and a second surface opposing the first surface, the enclosure defining the arm tip and an internal volume spanning between the arm tip and the arm hinge. The head-mountable display can further include a frame positioned inside the internal volume, the frame including a chassis and a hinge connection. In certain instances, the head-mountable display further includes a printed circuit board (PCB) mounted to the chassis.

### CROSS-REFERENCE TO RELATED APPLICATION(S)

This application is a National Stage filing based off of PCT Application No. PCT/US2023/068385, filed 13 Jun. 2023, and entitled “ARM INNER CHASSIS AND HINGE” which claims priority to U.S. Provisional Patent Application No. 63/366,402, filed 14 Jun. 2022, and entitled “ARM INNER CHASSIS AND HINGE,” the entire disclosure of which is hereby incorporated by reference.

### FIELD

The described embodiments relate generally to eyewear arms. More particularly, the present embodiments relate to one or more arm designs for electronic eyewear.

### BACKGROUND

Advances in software and computer hardware have increased at a rapid rate in

eyewear electronics (e.g., head-mountable electronics). Eyewear electronics are also being designed with reduced form factors to provide better aesthetics and conform to social norms. As the eyewear electronics are designed with smaller form factors, a variety of challenges are presented due to different approaches to assembly and internal component protection. Therefore, there is a need for assembly improvement, particularly for assembling securement arms with seamless enclosures. Additionally, there is a need for protecting internal components from incidental load application.

### SUMMARY

An aspect of the present disclosure relates to an arm of a head-mountable display that includes an arm tip, an arm hinge, and an enclosure. The enclosure can include a first surface, and a second surface opposing the first surface, the enclosure defining the arm tip and an internal volume spanning between the arm tip and the arm hinge. The head-mountable display can further include a frame positioned inside the internal volume, the frame including a chassis and a hinge connection. In some examples, the head-mountable display further includes a printed circuit board (PCB) mounted to the chassis.

In certain examples, the enclosure includes a seamless enclosure that defines an assembly access proximate to the arm hinge. In some examples, the frame is insertable into the internal volume through the assembly access. In particular examples, the frame is at least partially deformable. In one or more examples, the frame further includes a first material and a second material that differs from the first material. In certain implementations, the first material is a plastic material, and the second material is a metal material. In some examples, the frame includes a plastic material. In other examples, the frame includes a metal material.

Another aspect of the present disclosure relates to a head-mountable device. In some embodiments, a head-mountable device includes a display, and an arm connected to the display. In some examples, the arm includes an arm housing that includes a uni-body enclosure. In particular examples, the arm further includes a frame connected to the arm housing at a joint and cantilevered from the joint within the arm housing.

In certain examples, the frame of the head-mountable device further includes a metal portion and a plastic portion. In particular examples, the metal portion includes a titanium material. In some examples, the plastic portion includes a carbon fiber filled nylon material.

In some examples, the joint attaches the metal portion to the arm housing. In certain examples, the frame includes a nano-geometry engagement feature between the metal portion and the plastic portion.

In one or more embodiments, the head-mountable device further includes an arm hinge connecting the arm to the display. Additionally, the head-mountable device can further include a rigid hinge connection defined by the frame and connected to the arm hinge, the rigid hinge connection defining a cable pathway through the rigid hinge connection. Further, in some examples, the arm of the head-mountable device can include at least one of a speaker or a microphone attached to the frame, a printed circuit board (PCB) mounted to the frame, and a battery mounted to the frame.

Yet another aspect of the present disclosure relates to an arm subassembly of an augmented reality (AR) glasses arm. The arm subassembly can include a chassis, a printed circuit board (PCB), and a cable bundle. In some examples, the chassis defines an opening in a central region of the chassis. In particular examples, the chassis includes a deformable portion, a rigid portion, and a hinge connection defining a cable pathway between a first aperture and a second aperture of the hinge connection. In one or more examples, the PCB is disposed within the opening. Additionally, in one or more examples, the cable bundle extends from the PCB and through the first aperture and the second aperture.

In some examples, the arm subassembly further includes an interposer plate (or plate) connecting the deformable portion and the rigid portion across the opening. In addition, the arm subassembly can include a battery attached to the interposer plate.

In some examples, the rigid portion includes a tooling access backfilled with material sintered to the rigid portion. In particular examples, the chassis includes a curved periphery that covers an edge of the PCB.

In some examples, the deformable portion of the arm subassembly includes a first datum. The rigid portion can include a second datum. Further, in one or more examples, the first datum abuts the second datum.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a top view of an example of a head-mountable display worn on a head of a user.

FIG. 2 illustrates a schematic view of an example frame for assembly into an enclosure.

FIG. 3 illustrates a cross-sectional top view of an example arm of a head-mountable display.

FIG. 4 illustrates a cross-sectional top view of an example arm of a head-mountable display.

FIG. 5 illustrates a cross-sectional top view of an example arm of a head-mountable display.

FIG. 6 illustrates a cross-sectional top view of an example arm of a head-mountable display.

FIGS. 7A-7B illustrate top and bottom perspective views of an example frame for an arm subassembly of a head-mountable display.

FIG. 8 illustrates a partially exploded view of an example arm subassembly.

FIG. 9 illustrates a cross-sectional top view of an example arm of a head- mountable display.

FIGS. 10A-10B illustrate top and bottom perspective views of an example interposer plate being implemented with an example frame.

FIG. 11 illustrates a partially exploded view of an example flex electrical harness being implemented with an example frame and an example interposer plate.

### DETAILED DESCRIPTION

The following description will provide detailed reference to representative embodiments illustrated in the accompanying drawings. The following descriptions are not intended to limit the embodiments to one preferred embodiment. The following descriptions are intended to cover alternatives, modifications, and equivalents as can be included within the spirit and scope of the described embodiments as defined by the appended claims.

The following disclosure relates to a head-mountable display. Examples of head-mountable displays can include virtual reality or augmented reality devices that include an optical component. In the case of augmented reality devices, optical eyeglasses can be worn on the head of a user such that optical lenses and/or optical displays are positioned in front of the user's eyes. In another example, a virtual reality device can be worn on the head of a user such that a display screen is positioned in front of the user's eyes.

In particular examples, a head-mountable display includes a display to present visualizations, an arm housing (or enclosure) connected to the display, and an arm subassembly inserted inside the arm housing. The arm housing can interface with a user to secure a display in position (e.g., in front of a user's eyes). In one example, the arm housing extends from an arm tip to an arm hinge. The arm tip can be positioned behind a user's ear. The arm hinge can connect to a hinge for rotatably connecting the arm housing to the display.

The arm subassembly can include a variety of different components for operation of a head-mountable display. Example components of an arm subassembly include a microphone, speaker, battery, printed circuit board (PCB), system on chip, etc. Other examples components of an arm subassembly include a chassis and hinge connection.

Conventional arrangements of these or other components of an arm subassembly are incompatible with certain enclosures. For instance, assembly of arm components inside of an arm enclosure can be particularly challenging (or impossible) for non-clam shell enclosures. Indeed, conventional component arrangements typically include component assembly in the open, clam-shell configuration where the top (or bottom) half of the enclosure is opened or left off to allow assembly access. Once the conventional assembly is completed, the top (or bottom) half of the enclosure is closed over the opposing half.

By contrast, the disclosed devices can specifically enable uni-body enclosures (e.g., seamless enclosures). Such uni-body enclosures can include a single assembly access at a localized area of the arm (e.g., near the hinge). An arm subassembly (preassembled as a modular unit) can be pushed or inserted through the assembly access into an internal volume of the arm. Uni-body enclosures assembled in this manner can provide different advantages, including a more socially acceptable (or sleek) arm profile and the elimination of a seam that may cause discomfort to the user. Further, internal components can be designed to protect against external loading from assembly processes and ordinary consumer use.

A variety of different component configurations and designs within the scope of the present disclosure can be implemented to achieve the foregoing. For example, in some examples, the arm of the disclosed devices includes a frame. The frame can include an arm chassis. In certain embodiments, the arm chassis includes multiple materials. For instance, the arm chassis includes a rigid portion (e.g., a metal portion) and a deformable portion (e.g., a plastic portion). Using multiple materials, the arm chassis can provide cross-functionality as will be discussed below. Additionally or alternatively, the arm chassis includes a single material (e.g., all metal or all plastic).

In certain examples, the deformable portion of the arm chassis provides increased flexibility to the frame, in addition to increased component protection and improved weight-savings. To illustrate, the deformable portion of the arm chassis can flex or bend during assembly (e.g., to fit through the assembly access). Similarly, the deformable portion of the arm chassis can flex or bend during assembly to adjustably conform to the curvature of the enclosure when pushed through the arm into position. In addition, the components mounted to the deformable portion of the arm chassis can be protected against external loading. For instance, the deformable portion of the arm chassis can be decoupled from the enclosure such that stresses and strains do not transfer from the enclosure to the mounted components. The deformable portion can also be made of a lightweight, strong material, thereby lending to improved weight reduction and strength-to-weight ratios.

In some examples, the rigid portion of the arm chassis provides mechanical, load-bearing strength. For example, the rigid portion of the arm chassis is joined to the arm enclosure at a joint. In turn, the arm chassis can be cantilevered from the joint within the enclosure. The rigid portion of the arm chassis is sufficiently strong to bear the load of other portions of the arm chassis, including the deformable portion and mounted components.

In certain examples, the frame includes a hinge connection. In one or more examples, the hinge connection is defined by the rigid portion of the arm chassis. In particular examples, the hinge connection defines a cable pathway. Via the cable pathway, a cable bundle can be efficiently routed through the arm of a head-mountable display. Such efficient cable routing can help provide a sleek arm profile. Additionally, the rigidity of the hinge connection can protect a cable bundle during hinge cycling (e.g., opening and closing of the arm).

In some examples, the frame includes an open, hollow design. For example, the frame includes an opening in a central region of the frame. The open, hollow design of the frame can lend to increased space utilization and improved load decoupling. Additionally or alternatively, the open, hollow design of the frame can lend to improved weight savings and material consumption.

A variety of different components can mount to the frame (e.g., as part of an arm subassembly). For example, components sensitive to stresses and strains can mount to the frame. As particular examples of components, a PCB, a battery, a speaker, or a microphone can mount to the frame. As another example, an interposer plate can mount to the frame. In certain examples, the interposer plate can optimize a space for a battery within an arm subassembly.

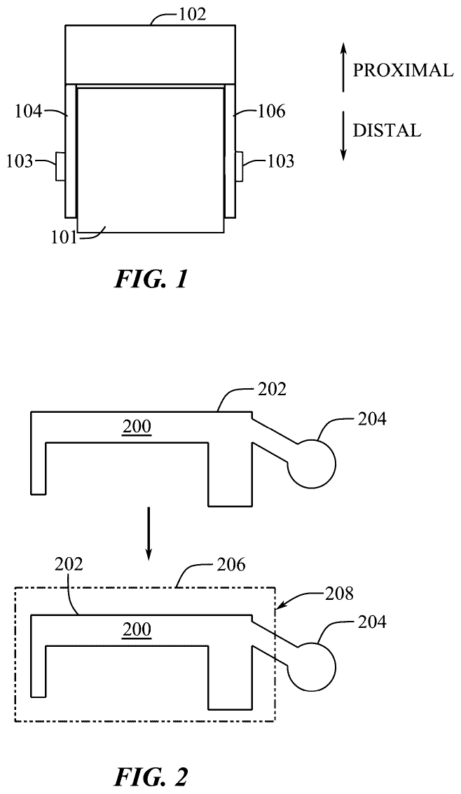

These and other examples are discussed below with reference to FIGS. 1-11. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a top view of an example of a head-mountable display 100 worn on a head 101 of a user. The head-mountable display 100 can include a display 102 (e.g., one or more optical lenses or display screens in front of the eyes of the user). The display 102 can include a display for presenting an augmented reality visualization, a virtual reality visualization, or other suitable visualization.

The head-mountable display 100 can also include one or more arms 104, 106. The arms 104, 106 are connected to the display 102 and extend distally toward the rear of the head 101. The arms 104, 106 are configured to secure the display 102 in a position relative to the head 101 (e.g., such that the display 102 is maintained in front of a user's eyes). For example, the securement arms 104, 106 extend over the user's ears 103. In certain examples, the arms 104, 106 rest on the user's ears 103 to secure the head-mountable display 100 via friction between the arms 104, 106 and the head 101. Additionally or alternatively, the arms 104, 106 can rest against the head 101. For example, the arms 104, 106 can apply opposing pressures to the sides of the head 101 to secure the head-mountable display 100 to the head 101.

The terms “proximal” and “distal” can be used to reference the position of various components of devices described herein relative to the display 102 of the head-mountable display 100. The orientation of the “proximal” and “distal” directions relative to devices described herein is shown in FIG. 1.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1. Further details of the frame that can be used in the arms 104, 106 of the head-mountable display 100 are provided below with reference to FIG. 2.

FIG. 2 illustrates a schematic view of an example frame 200 for assembly into an enclosure 206. The frame 200 and the enclosure 206 can be implemented in one or more of the arms 104, 106 discussed above in relation to FIG. 1.

As used herein, the term “frame” refers to a structural member or body inside the arm of a head-mountable display. For example, the frame 200 can mount or support other components. In certain examples, the frame 200 can also provide a particular framework of elements (e.g., members, surfaces, cutouts, etc.) arranged as a platform tailored to receive, position, secure, route, protect, cover, space apart, insulate, or thermally couple certain components. In particular examples, the frame 200 includes an assembly skeleton, chassis, or base for assembling components into a predetermined configuration (e.g., a modular unit or arm subassembly).

Additionally, as used herein, the terms “enclosure” or “housing” refer to a body portion of an arm of a head-mountable display. In some examples, the enclosure 206 defines the outer shell or surface profile of an arm. As will be discussed below, in some examples, the enclosure 206 is a uni-body enclosure or a seamless enclosure.

In particular examples, the frame 200 (as part of an arm subassembly) can be inserted into the enclosure 206. For example, the frame 200 can be inserted inside the enclosure 206 via an assembly access 208 positioned at a localized region of the arm (e.g., proximate the hinge at a proximal end of the arms 104, 106 shown in FIG. 1). The assembly access 208 can be sized and shaped to receive the frame 200 (and other mounted components not shown). In certain implementations, at least a portion of the frame 200 is deformable for inserting inside a uni-body type enclosure for the enclosure 206 (in which case, the frame 200 is configured like a ship-in-a-bottle).

The ship-in-a-bottle approach is different from conventional assembly methods implementing a clam-shell enclosure that facilitates assembly completion with a top (or bottom) half of the enclosure opened. Moreover, the ship-in-a-bottle approach is superior to conventional clam-shell assembly methods because uni-body enclosures can provide comparatively smaller form factors.

As shown in FIG. 2, the frame 200 includes an arm chassis 202. The arm chassis 202 can mount a PCB, a battery, a speaker, or a microphone. As will be described more below in relation to subsequent figures, the arm chassis 202 can mount these or other components in a way that protects components against external loading.

Still further, in some examples, the frame 200 can include a mechanism for movement. For example, the frame 200 includes a hinge connection 204. The hinge connection 204 can connect the arm to the display of a head-mountable display. Via the hinge connection 204, the arm of a head-mountable display can rotate relative to the display (e.g., between open and closed configurations).

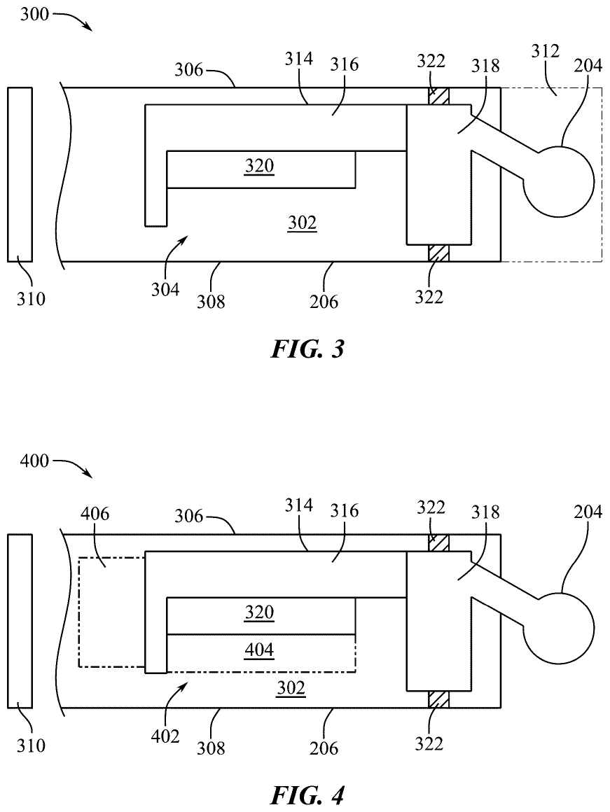

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2. Further details of how the exemplary frame 200 can be incorporated into a head-mountable display are provided below with reference to FIG. 3.

FIG. 3 illustrates a cross-sectional top view of an example arm 300 of a head-mountable display. The arm 300 can be the same as or similar to the arms 104, 106 discussed above in relation to FIG. 1.

As shown, the arm 300 includes the enclosure 206 discussed above in relation to FIG. 2. Indeed, the enclosure 206 defines the outer shell or surface profile of the arm 300. In particular examples, the enclosure 206 includes a first surface 306 and a second surface 308. The first surface 306 and the second surface 308 extend at least partially between an arm tip 310 and an arm hinge 312, thereby defining an internal volume 302 inside the arm 300. In certain instances, the first surface 306 and the second surface 308 span an entire distance between the arm tip 310 and the arm hinge 312.

As used herein, the terms “arm tip” or “tip of the arm” refer to an end region of the arm 300, as defined by the enclosure 206. The arm tip 310 can be positioned behind a user's ear 103. Additionally or alternatively, the arm tip 310 can press against the head 101 of a user for securing a head-mountable display. The arm tip 310 is positioned opposite of another end region of the arm 300 that abuts or connects to the arm hinge 312.

Additionally, as used herein, the term “arm hinge” refers to a hinge joint between the arm 300 and the display 102 (shown in FIG. 1). Further detail with respect to the arm hinge 312 will be discussed below.

In some examples, the enclosure 206 includes a uni-body enclosure. For example, the first surface 306 and the second surface 308 form an integral whole or combination. To illustrate one example, the first surface 306 and the second surface 308 combine together, mate, or join such that the enclosure 206 forms a singular shell. As another example, the first surface 306 and the second surface 308 reference discrete portions, sides, or regions of an otherwise indiscrete whole body of the arm 300. It will be appreciated that forming the enclosure 206 can be accomplished in myriad different ways (e.g., casting, injection molding, three-dimensional printing, machining, etc.).

In addition, the enclosure 206 can include a variety of different materials. In some examples, the enclosure 206 includes a metal material. For example, the enclosure 206 can include one or more base metals, such as titanium, stainless steel, tungsten, cobalt, aluminum, copper, lead, nickel, tin, zinc, gold, silver, etc. Additionally or alternatively, in certain examples, the enclosure 206 can include materials other than metal. For example, the enclosure 206 can include a polymer material, a carbon fiber material, a glass material, etc. Combinations of the foregoing are also herein contemplated. For instance, the enclosure 206 can be composed of one or more base materials, in addition to one or more coatings.

Further shown in FIG. 3, the enclosure 206 defines the assembly access 208 into the internal volume 302 within the arm 300. The assembly access 208 can be positioned in a myriad of different locations along the arm 300. For instance, as illustrated, the assembly access 208 can be positioned proximate to the arm hinge 312. As an alternative example, the assembly access 208 can be positioned at the arm tip 310. In yet another example, the assembly access 208 can be positioned between arm tip 310 and the arm hinge 312. In certain examples, the assembly access 208 can be sized and shaped to allow insertion of an arm subassembly 304 into the internal volume 302.

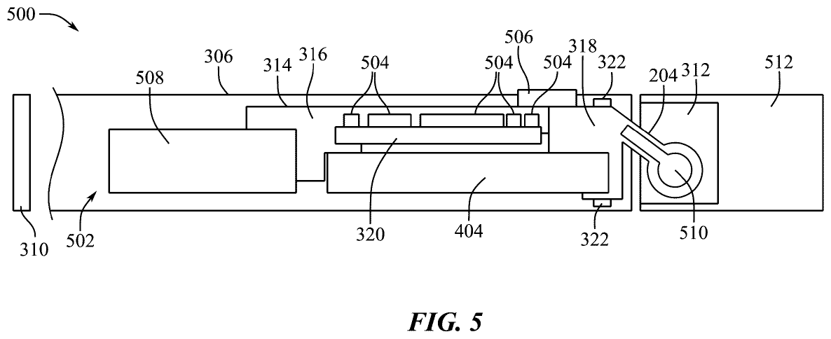

As used herein, the term “arm subassembly” refers to components inside the arm 300. In particular examples, the arm subassembly 304 includes components assembled together as a unit for inserting into the enclosure 206. In some examples, the arm subassembly 304 includes a frame 314 and a printed circuit board (PCB) 320 (among myriad other possible components as discussed, for instance, in FIGS. 4-5). Each is discussed in turn.

As shown in FIG. 3, the frame 314 includes a deformable portion 316. As used herein, the term “deformable” refers to a type or section of frame material that can bend, flex, move, or modify its shape or form in response to a given force. Accordingly, in some examples, the deformable portion 316 can plastically deform with permanent or semi-permanent deformation in response to a force (e.g., an insertion force to insert the frame 314 into the internal volume 302). Additionally or alternatively, the deformable portion 316 can elastically deform such that the deformable portion 316 can rebound to an original shape or form after deformation responsive to a force. In one or more examples, the deformable portion 316 can mount certain components (e.g., the PCB 320).

The deformable portion 316 can include a variety of different materials. For example, the deformable portion 316 can include a polymer material, a composite material, a carbon fiber material, a metal material, a rubber material, a silicone material, etc. Combinations of the foregoing are also herein contemplated. For example, the deformable portion 316 can include a carbon fiber filled nylon (e.g., Kalix 1330, Nylon 12CF). As another example, the deformable portion 316 can include acrylonitrile butadiene styrene. In yet another example, the deformable portion 316 can include a polycarbonate.

Further shown in FIG. 3, the frame 314 includes a rigid portion 318. As used herein, the term “rigid” refers to a type or section of frame material that is sufficiently hardened to support a load (e.g., the cantilevered weight of the frame 314 and mounted components). In addition, the term rigid refers to a type or section of frame material that is sufficiently hardened to cycle many times (e.g., at least hundreds or thousands of times) in a hinge joint. Accordingly, in some examples, the rigid portion 318 includes a material with a hardness level of at least 3 (according to Moh's relative hardness level). In certain examples, the rigid portion 318 can include a material with a Moh's hardness level between 4 and 10. In particular examples, the rigid portion can include a material with a Moh's hardness level between 5.5 and 9.

In some examples, the rigid portion 318 can include one or more base metals, such as titanium, stainless steel, tungsten, cobalt, aluminum, copper, lead, nickel, tin, zinc, gold, silver, etc. Additionally or alternatively, in certain examples, the rigid portion 318 can include materials other than metal. For example, the rigid portion 318 can include a polymer material, a carbon fiber material, a diamond material, a graphite material, silicon carbide material, etc. Combinations of the foregoing are also herein contemplated. For example, the rigid portion 318 can include an alpha-beta titanium alloy (Ti-6AL-4v).

It will be appreciated that the deformable portion 316 and the rigid portion 318 of the frame 314 can include an arm chassis (e.g., the arm chassis 202 discussed above in relation to FIG. 2). That is, an arm chassis can include part of the deformable portion 316 and part of the rigid portion 318. The term “chassis” refers to the one or more members that are connected to the arm hinge 312. In particular examples, the chassis is configured to bear a load from one or more components mounted thereto. In certain examples, the chassis transfers or distributes this load to the arm hinge 312.

It will be appreciated that a multi-material chassis can provide various advantages. For example, a flexible chassis portion (e.g., the deformable portion 316) can be manipulated or deformed as needed for assembling into the internal volume 302 via the assembly access 208. Further, a flexible chassis portion can provide independent support for mounted components (e.g., the PCB 320) without transferring external loads applied to the enclosure 206.

By contrast, the rigid chassis portion (e.g., the rigid portion 318) can be attached to the enclosure 206 via a joint 322 to cantilever the frame 314 from the joint 322 within the enclosure 206. In this manner, the rigid portion 318 can decouple the deformable portion 316 (and corresponding components) from external loads applied to the enclosure 206. Further, the rigid chassis portion can efficiently and dependably transfer a load from the frame 314 to the arm hinge 312 via the hinge connection 204.

In alternative examples, the deformable portion 316 and the rigid portion 318 are not composed of differing materials. Instead, the deformable portion 316 and the rigid portion 318 form a single, uniform material (or combination of materials). For example, in certain examples, an all plastic material or an all metal material can accomplish a same or similar functionality just described.

As mentioned, the arm subassembly 304 can include the PCB 320. The terms “PCB” or “printed circuit board” refer to a logic assembly that includes electronic components. The PCB 320 can include electrical connections and circuitry for mounting various components, including a system on chip or integrated circuit. The PCB 320 can also relay power to mounted electrical components from a power source (e.g., a battery, not shown in FIG. 3). In certain examples, the PCB 320 is a main logic board. The PCB 320 can be a rigid board (e.g., composed of glass-epoxy compounds). In some examples, the PCB 320 is a multi-layer PCB (e.g., a laminated sandwich structure of conductive and insulating layers). In some examples, the PCB 320 can be flexible (e.g., with flexible circuitry made with polyimide). In certain examples, the PCB 320 includes stiffeners added via lamination or pressure sensitive adhesive.

The PCB 320 can mount to the deformable portion 316 in one or more different ways. In some examples, the PCB 320 is mechanically attached to the deformable portion 316 (e.g., via one or more fasteners). In other examples, the PCB 320 is bonded or adhered to the deformable portion 316 (e.g., using pressure sensitive adhesive). Additionally or alternatively, the PCB 320 is encapsulated into position (e.g., adjacent to or abutting the deformable portion 316) by an epoxy molding compound.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3. Further details and examples of the arm configuration are provided below with reference to FIG. 4.

FIG. 4 illustrates a cross-sectional top view of an example arm 400 of a head- mountable display. The arm 400 can be the same as or similar to the arms 104, 106 discussed above in relation to FIG. 1.

As shown, the arm 400 includes the enclosure 206 defined by the first surface 306 and the second surface 308 discussed above in relation to FIG. 3. In addition, the arm 400 includes an arm subassembly 402 which includes the PCB 320 also discussed above in relation to FIG. 3. The arm subassembly 402 further includes the frame 314 cantilevered within the enclosure 206 via the joint 322, as described above in relation to FIG. 3. Further, albeit not shown in FIG. 4, the arm 400 spans between an arm tip and arm hinge as similarly described above in relation to the arm tip 310 and the arm hinge 312 of FIG. 3.

Different from FIG. 3, however, the arm subassembly 402 can include one or more optional components, such a battery 404 or an element 406. In some examples, the arm subassembly 402 includes both. Each is discussed in turn.

The battery 404 can include a rechargeable battery. For example, the battery 404 can include a nickel-cadmium battery, a nickel-metal hydride battery, a lithium ion battery, a lithium-ion polymer battery, a lead-acid battery, or a rechargeable alkaline battery. Additionally or alternatively, the battery 404 can include a storage battery or a secondary cell.

The element 406 can include one or more components or design configurations. In some examples, the element 406 can include an air gap, a heat sink, vapor chamber, or an insulation material. Additionally or alternatively, the element 406 can include a battery, speaker, microphone, etc. In particular examples, the element 406 can include a combination of the foregoing, such as a speaker-microphone combination.

The battery 404 and the element 406 can mount to the frame 314 in one or more different ways. In some examples, these components are mechanically fastened to the frame 314 (e.g., the deformable portion 316). In other examples, these components are bonded or adhered to the frame 314 (e.g., using pressure sensitive adhesive). Other suitable methods of attaching components together are within the scope of the present disclosure.

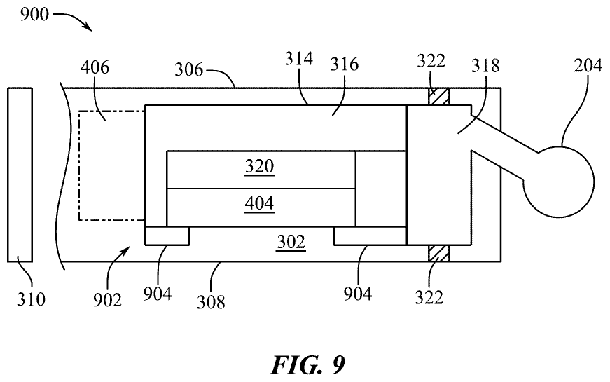

It will be appreciated that at least one of the battery 404 or the element 406 is mounted to a component other than the frame 314. For example, in certain examples, at least one of the battery 404 or the element 406 is mounted to the PCB 320. Further, in some examples, at least one of the battery 404 or the element 406 is mounted to a component of the arm subassembly 402 not shown (e.g., an interposer plate described below in relation to FIGS. 9-11).

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4. Additional details regarding the example arm configuration are provide below with reference to FIG. 5.

FIG. 5 illustrates a cross-sectional top view of an example arm 500 of a head-mountable display. The arm 500 can be the same as or similar to the arms 104, 106 discussed above in relation to FIG. 1.

The arm 500 is similar to the arm 400 discussed above in relation to FIG. 4. In particular, the arm 500 can include an arm subassembly 502 that includes the frame 314, the PCB 320, and the battery 404 discussed above.

As shown in FIG. 5, however, the arm subassembly 502 further includes components 504 mounted to at least one of the PCB 320 or the frame 314 (e.g., the deformable portion 316). In some examples, the components 504 are mounted to both of the PCB 320 and the deformable portion 316. The components 504 can include a variety of different components. Example components include a heat source (or system on chip), integrated circuit, or other suitable electronic components (e.g., resistors, capacitors, inductors, potentiometers, transformers, diodes, transistors, etc.).

Additionally shown in FIG. 5, a button 506 can be disposed on or through the first surface 306 of the enclosure 206. The button 506 can also attach or interface with the frame 314 (or associated components, such as the PCB 320). In some examples, the button 506 is a power button to power on the head-mountable display. In other examples, the button 506 includes a visualization control button to start, pause, stop, change, or otherwise interact with a visualization presented via the head-mountable display.

The arm subassembly 502 further includes a speaker-microphone 508. The speaker-microphone 508 can include one or more components for receiving, processing, transmitting, amplifying, or otherwise engaging in audio processes. The speaker-microphone 508 can mount to the frame 314 (e.g., the deformable portion 316) via mechanical fasteners, bonding, pressure-sensitive adhesive, or other suitable methods.

Further shown in FIG. 5, the hinge connection 204 defines a cable pathway 510. The cable pathway 510 can include a hollowed out section or slot through the hinge connection 204. In one or more examples, the cable pathway 510 can be sized and shaped to receive a cable bundle (not shown). More particularly, the cable pathway 510 can be oriented to route a cable bundle through the hinge connection 204 such that a cable bundle can extend between the PCB 320 and components in a temple region 512 of a head-mountable display.

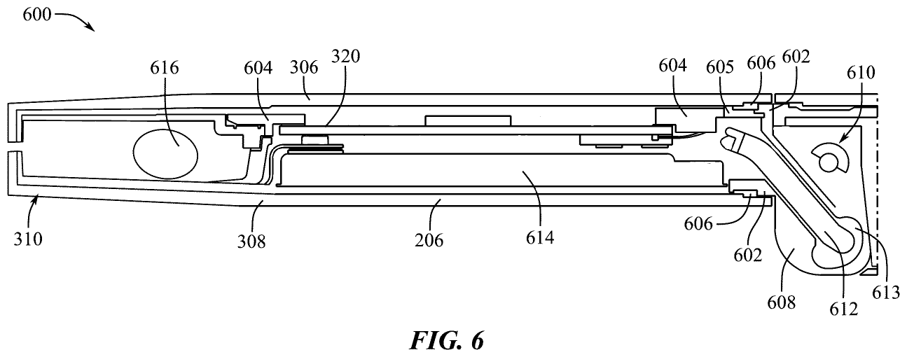

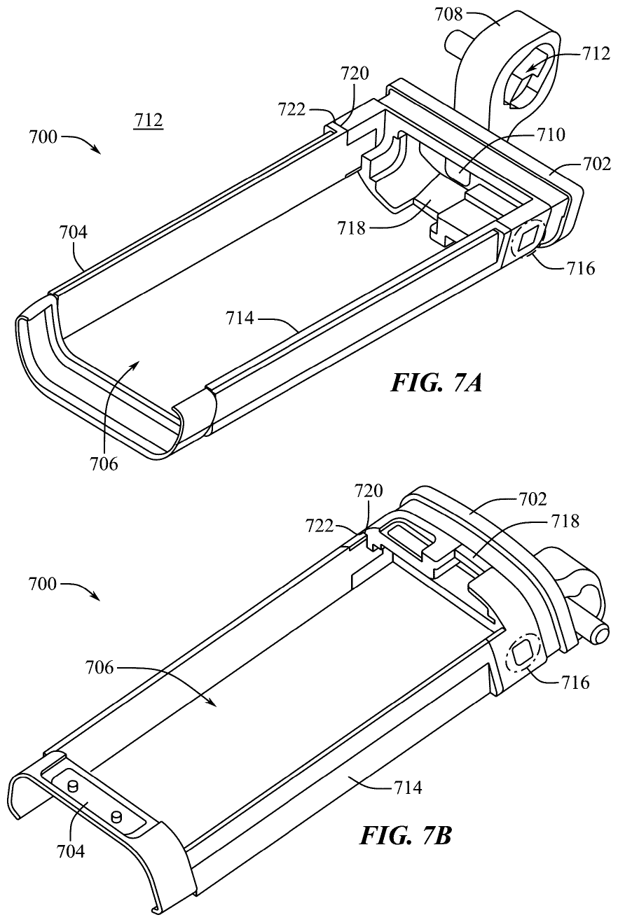

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5. Further details of the example arm configuration are provided below with reference to FIG. 6.

FIG. 6 illustrates a cross-sectional top view of an example arm 600 of a head-mountable display. The arm 600 can be the same as or similar to the arms 104, 106 discussed above in relation to FIGS. 1-2.

The arm 600 includes a particular arrangement of components within the scope of the present disclosure for implementing a frame as an inner arm chassis and hinge mechanism. As shown, the arm 600 includes a metal chassis portion 602 and a plastic chassis portion 604. The metal chassis portion 602 is affixed to the interior portion of the first surface 306 of the enclosure 206 at a joint 606.

The arm 600 further includes a hinge connection 608 extending from the metal chassis portion 602. The hinge connection 608 and a hinge assembly 610 work together to provide a rotatable hinge joint for the arm 600 such that the arm 600 can rotate between open and closed positions relative to the display 102 (shown in FIGS. 1-2).

Disposed within the hinge connection 608 includes a cable bundle 612 routed through a cable pathway 613 defined by the internal walls of the hinge connection 608.

A tooling access 605 is defined between the metal chassis portion 602 and the plastic chassis portion 604. Via the tooling access 605, a cable pathway (for the cable bundle 612) in the hinge connection 608 can be machined, deburred, cleaned, polished, surface treated, coated, etc. In turn, the tooling access 605 can be backfilled. For example, the tooling access 605 can be backfilled with a patch co-sintered to the metal chassis portion 602. Accordingly, the tooling access 605 can be backfilled with a same or similar material as the metal chassis portion 602. Alternatively, the tooling access 605 is backfilled with a same or similar material as the plastic chassis portion 604.

It will be appreciated that the plastic chassis portion 604, the metal chassis portion 602, and the hinge connection 608 as just discussed can make up the frame 314 discussed above in relation to the foregoing figures. Indeed, the plastic chassis portion 604 can correspond to the deformable portion 316, the metal chassis portion 602 can correspond to the rigid portion 318, and the hinge connection 608 can correspond to the hinge connection 204.

In addition, the arm 600 can include a battery 614. The battery 614 can be positioned between the PCB 320 and the second surface 308. Besides a power connection between the battery 614 and the PCB 320, an air gap can surround the battery 614. Furthermore, the arm 600 can include any number of audio components including a speaker 616. The speaker 616 can be positioned near the arm tip 310 of the arm 600 for convenient placement near a user's ear during use.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6. Further details of an example frame 314 are provided below with reference to FIGS. 7A and 7B.

FIGS. 7A and 7B illustrate top and bottom perspective views of an example frame 700 of an arm subassembly for a head-mountable display, respectively. In particular, FIGS. 7A and 7B show the frame 700 including a rigid portion 702, a deformable portion 704, and a hinge connection 708. The rigid portion 702, the deformable portion 704, and the hinge connection 708 can respectively correspond to the deformable portion 316, the rigid portion 318, and the hinge connection 204 discussed above. Additionally or alternatively, the rigid portion 702, the deformable portion 704, and the hinge connection 708 can respectively correspond to the metal chassis portion 602, the plastic chassis portion 604, and the hinge connection 608 also discussed above.

In addition to these components, the rigid portion 702, the deformable portion 704, and the hinge connection 708 can also define certain features. For example, the hinge connection 708 defines a cable pathway between a first aperture 710 and a second aperture 712. Through the cable pathway, a cable bundle (not shown) can be efficiently routed to extend through the first aperture 710, through the cable pathway, and through the second aperture 712. As mentioned previously, this cable routing can help provide a reduced form factor for a sleek arm profile.

It will be appreciated that the first aperture 710, the second aperture 712, and connecting cable pathway can be tooled in various ways. In certain examples, the first aperture 710, the second aperture 712, and the connecting cable pathway are tooled through a tooling access. For example, the first aperture 710, the second aperture 712, and the connecting cable pathway can be machined, deburred, cleaned, polished, surface treated, coated, etc. via the tooling access.

Backfilled portions 718 can correspond to the tooling access just described. Indeed, after tooling is performed via the tooling access, the backfilled portions 718 may be formed. In some examples, the backfilled portions 718 include a patch of material sintered to the rigid portion 702 or the hinge connection 708. Accordingly, the backfilled portions 718 can be backfilled with a same or similar material as the rigid portion 702 and the hinge connection 708 (e.g., a titanium alloy). Alternatively, the backfilled portions 718 are backfilled with a same or similar material as the deformable portion 704.

In one or more examples, the deformable portion 704 largely defines the size and shape of the frame 700. In particular examples, the deformable portion 704 includes a flattened C-shape curvature. In certain examples, the curvature of the deformable portion 704 matches the curvature and shape of at least a portion of an arm enclosure (not shown). Additionally or alternatively, the shape and curvature of the deformable portion 704 corresponds to component edges for at least partially protecting or covering. For example, a curved periphery 714 of the deformable portion 704 can cover component edges, such as a PCB edge of a PCB disposed within an opening 706.

In addition, the deformable portion 704 defines the opening 706 within a central region of the frame 700. The opening 706 can be sized and shaped to allow increased space utilization for components mounted to the frame 700. The opening 706 can also allow for thermal coupling between components mounted to the frame 700 and an arm enclosure (not shown).

In one or more examples, the rigid portion 702 and the deformable portion 704 are connected via one or more engagement features 716. In some examples, the engagement features 716 can include an interlocking element that interlocks the rigid portion 702 and the deformable portion 704. In certain implementations, the engagement features 716 include nano-geometry engagement features (e.g., dovetail elements, snap fits, press fits, tongue-and-groove elements, etc. sized on a nanoscale). Additionally or alternatively, the engagement features 716 include a co-bonded portion, a sintered portion, an adhesive portion, etc. that transitions between and connects the rigid portion 702 and the 704.

Further shown in FIGS. 7A and 7B, the deformable portion 704 includes one or more datums 720, and the rigid portion 702 includes one or more datums 722. The datums 720, 722 include respective faces or surfaces of the deformable portion 704 and the rigid portion 702 that correspond to mechanical stops. In particular examples, the datums 720, 722 include abutment faces. For example, the datums 720 of the deformable portion 704 abut the datums 722 of the rigid portion 702.

It will be appreciated that forming the frame 700 can be accomplished in myriad different ways (e.g., casting, injection molding, three-dimensional printing, machining, etc.). Further, in some examples, the frame 700 can be formed utilizing separate process for individual components. For example, in one manufacturing approach, the deformable portion 704 and the hinge connection 708 can be metal injection molded. As another example, the rigid portion 702 can be three-dimensionally printed or molded using polymer injection molding.

It will further be appreciated that manufacturing processes of forming the frame 700 can account for subsequent manufacturing processes. For example, the deformable portion 704 and the hinge connection 708 can be metal injection molded at a slightly larger size to account for material shrinkage as the metal cools. Additionally or alternatively, components can be formed slightly larger to achieve tight, accurate machining tolerances (as may be desired, particularly for nano-geometry engagement features).

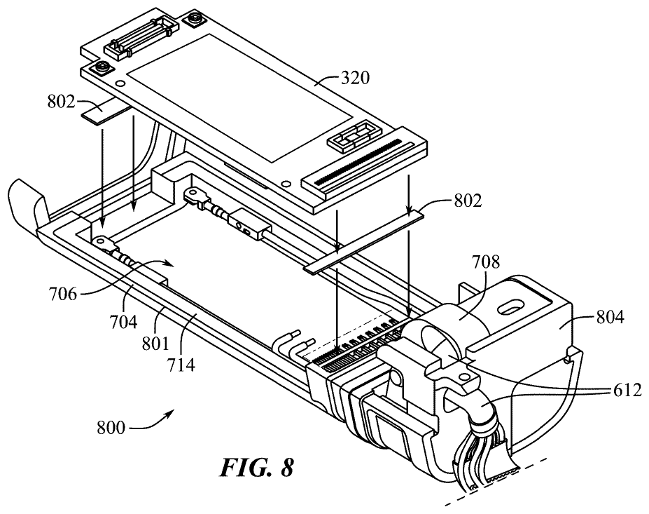

Any of the features, components, and/or parts, including the arrangements and configurations thereof shown in FIGS. 7A and 7B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 7A and 7B. Assembly of the exemplary frame with additional components is provided below with reference to FIG. 8.

FIG. 8 illustrates a partially exploded view of an example arm subassembly 800. As shown in FIG. 8, the arm subassembly 800 includes a frame 801. The frame 801 is similar, but not the same as the frame 700 discussed above. Indeed, the frame 700 and the frame 801 differ because the frame 700 corresponds to a right-side arm (e.g., the arm 106 of FIG. 1) and the frame 801 corresponds to a left-side arm (e.g., the arm 104 of FIG. 1). However, the features between the frames 700, 801 are similar such that the subsequent discussion of various features for the frame 801 reference the features of the frame 700.

In particular, the arm subassembly 800 can include the PCB 320 mounting to the frame 801 via pressure sensitive adhesive strips 802. Additionally or alternatively, other forms of adhesive, fastening, or forms of attachment may be implemented. In so doing, the PCB 320 is disposed within the opening 706 such that edges of the PCB 320 are at least partially covered by the curved periphery 714 of the deformable portion 704.

Further shown in FIG. 8, the arm subassembly 800 can connect to an arm hinge 804 that engages the hinge connection 708. In particular, the hinge connection 708 includes a cable pathway to route a cable bundle 612. The cable bundle 612 includes one or more wires extending from the opening 706 (e.g., to connect with the PCB 320).

Additionally, the cable bundle 612 can extend through the hinge connection 708 (e.g., through first and second apertures discussed above). The cable bundle 612 can further exit the hinge connection 708 and the arm hinge 804 to fan out and make additional connections. It will be appreciated that such efficient cable routing can help to provide a sleek arm profile of a head-mountable display.

Any of the features, components, and/or parts, including the arrangements and configurations thereof shown in FIG. 8 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8. Further examples showing the incorporation of the arm subassembly into a head-mountable display are provided below with reference to FIG. 9.

FIG. 9 illustrates a cross-sectional top view of an example arm 900 of a head-mountable display. The arm 900 can be the same as or similar to the arms 104, 106 discussed above in relation to FIG. 1.

As shown, the arm 900 includes the same elements as the arm 400, but with one addition. In particular, the arm 900 includes an arm subassembly 902 that includes an interposer plate 904.

In one or more examples, the interposer plate 904 mounts to the frame 314. For example, the interposer plate 904 mounts to both the deformable portion 316 and the rigid portion 318 of the frame 314. In some examples, the interposer plate 904 includes a stiffener to provide increased rigidity and strength to the frame 314.

Additionally or alternatively, in certain examples, the interposer plate 904 can mount to certain components for providing component-specific support or providing an improved inter-component spacing. For example, the battery 404 can mount to the interposer plate 904. In certain examples, the interposer plate 904 positions the battery 404 into a particular location within the arm 900 that accounts for tolerance errors (e.g., tolerance stacking). As another example, the interposer plate 904 positions the battery 404 at a particular spacing or gap from the second surface 308 that accounts for battery swelling during a charge cycle. To illustrate, the interposer plate 904 provides an air gap between the battery 404 and the second surface 308 that is about 2% to about 40% of the nominal thickness of the battery. In other examples, the air gap is about 5% to about 20% of the nominal thickness of the battery. In particular examples, the air gap is about 10% of the nominal thickness of the battery.

It will be appreciated that the interposer plate 904 can include a variety of different materials. In some examples, the interposer plate 904 includes a same or similar material as the deformable portion 316. In other examples, the interposer plate 904 includes a same or similar material as the rigid portion 318. In certain implementations, the interposer plate 904 includes a 316 stainless steel material. Other example materials for the interposer plate 904 include recycle-friendly materials, thermal insulating materials, and the like.

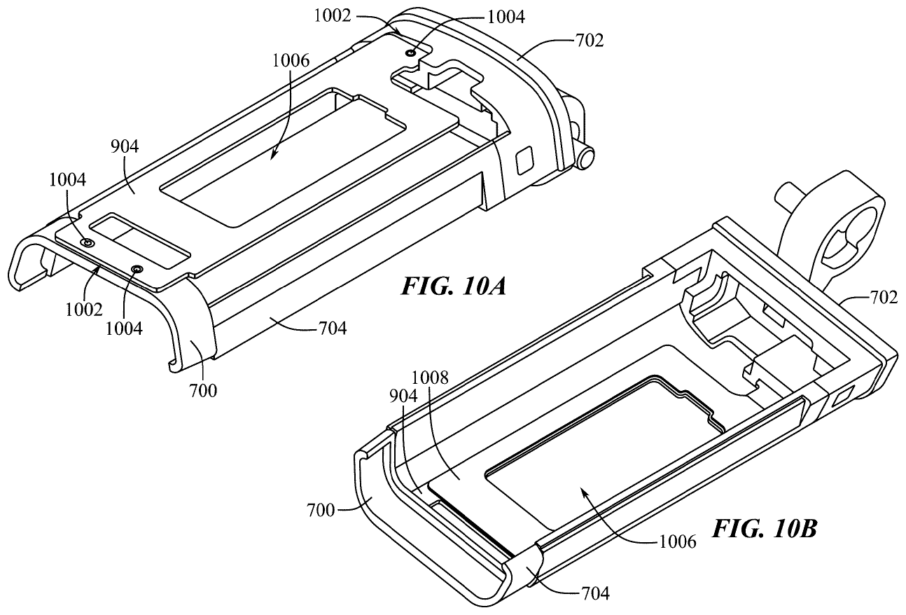

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 9. Further examples of how the interposer plate can be incorporated with the frame are provided below with reference to FIGS. 10A and 10B.

FIGS. 10A-10B illustrate top and bottom perspective views of an example interposer plate being implemented with an example frame. In particular, FIGS. 10A-10B depict the interposer plate 904 mounted to the frame 700, both discussed above. For example, the interposer plate 904 joins opposing ends of the frame 700 together. For instance, the interposer plate 904 mounts to the deformable portion 704 at one end of the frame 700, and the rigid portion 702 at the other end of the frame 700. Various surfaces of the frame 700 can be sized and shaped to mount the interposer plate 904. For instance, the frame 700 includes flattened, interfacing surfaces to engage and mount the interposer plate 904.

In particular examples, the interposer plate 904 is mounted to the frame 700 via glue joints 1002 (positioned between the interposer plate 904 and the frame 700). The glue joints 1002 can include various types of structural glue, such as 3M® 6011LV glue. In alternative examples, fasteners or other methods of attachment can be utilized to join the interposer plate 904 and the frame 700 together.

In at least some examples, alignment holes 1004 defined by the interposer plate 904 can help to ensure the interposer plate 904 is positioned accurately relative to the frame 700. For example, the alignment holes 1004 can correspond to alignment dowels of the frame 700. In certain examples, the alignment dowels (shown in FIG. 7) of the frame 700 are press-fit into the alignment holes 1004 in a mating fashion.

As further shown in FIGS. 10A-10B, the interposer plate 904 defines an opening 1006 between opposing surfaces of the interposer plate 904. In some examples, the opening 1006 is sized and shaped to at least partially expose a component surface mounted to the interposer plate 904. In other examples, the opening 1006 reduces an amount of material consumption and decreases an arm weight.

The interposer plate 904 includes a mounting surface 1008. The mounting surface 1008 can include a coating, adhesive, or other layer to receive a component for mounting (e.g., a battery). In some examples, the mounting surface 1008 can include a pressure sensitive adhesive (e.g., Nitto No. 5610, Tesa 4982, etc.). The amount (e.g., surface area, thickness) of the mounting surface 1008 can depend on various factors. In some examples, the surface area of the mounting surface 1008 is a function of attachment strength and hold over a duration of time. Additionally, in some examples, the thickness of the mounting surface 1008 is a function of mechanical damping, spatial constraints, etc. As an example, the thickness of the mounting surface 1008 includes a thickness of about 0.1 mm to about 1 mm. As another example, the thickness of the mounting surface 1008 includes a thickness of about 0.2 mm to about 6 mm. In certain implementations, the thickness of the mounting surface 1008 includes a thickness of about 0.4 mm.

In a similar vein, the thickness of the interposer plate 904 can include myriad different thicknesses. The thickness of the interposer plate 904 can add a desired strength or rigidity to the frame 700. Additionally or alternatively, the thickness of the interposer plate 904 can spatially determine a position of a mounted component (e.g., a battery) relative to other components or surfaces. Some example thicknesses of the interposer plate 904 include a thickness of about 0.01 mm to about 0.8 mm. In some examples, the thickness of the interposer plate 904 includes a thickness of about 0.02 mm to about 0.3 mm. In particular examples, the thickness of the interposer plate 904 includes a thickness of about 0.25 mm.

It will be appreciated that one or more surfaces of the interposer plate 904 can be coated or lined with certain materials to impart desired properties. In certain examples, the interposer plate 904 can include a coating to impart hardness, resist chemical exposure, or reduce electrical interference. Examples of coatings include a phenol formaldehyde resin, a bio-based resin (e.g., lignin, tannin, cardanol, hydroxymethylfurfural, and glyoxal), an epoxy molding compound, etc.

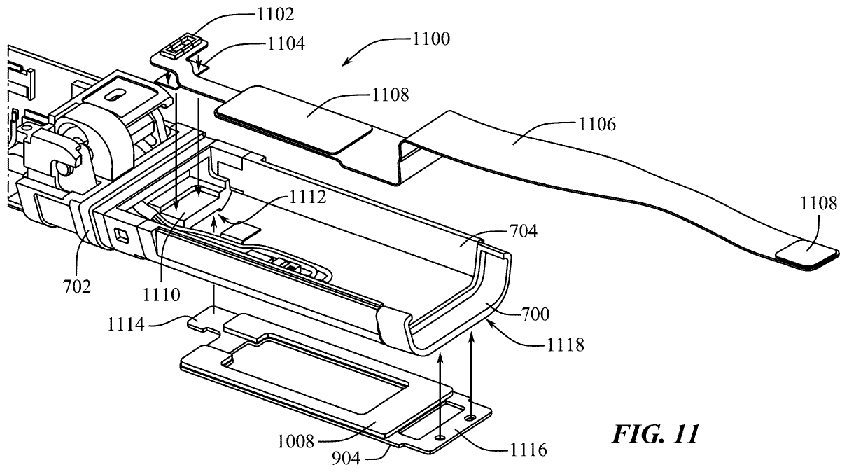

Any of the features, components, and/or parts, including the arrangements and configurations thereof shown in FIGS. 10A and 10B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 10A and 10B. Additional example construction configurations of the frame and its associated components are provided below with reference to FIG. 11.

FIG. 11 illustrates a partially exploded view of an example flex electrical harness 1100 being implemented with the frame 700 and the interposer plate 904 discussed above. With respect to the interposer plate 904, a mountable end 1114 of the interposer plate 904 is configured to engage a frame portion, namely a receiving surface 1112 of the rigid portion 702. In addition, a mountable end 1116 of the interposer plate 904 is configured to engage another frame portion, namely a receiving surface 1118 of the deformable portion 704. As discussed above, joint glue can affix the mounted portions.

Further shown in FIG. 11, the flex electrical harness 1100 is configured to mount to the frame 700. In particular, an electrical tab 1102 can engage a receiving surface 1110 of the rigid portion 702 via a pressure sensitive adhesive strip 1104. In some examples, the receiving surface 1110 opposes the receiving surface 1112. Other portions of the flex electrical harness 1100 can mount to the frame 700 or the interposer plate 904 (albeit not required).

The electrical tab 1102 can include one or more electrical components, such as an integrated circuit, resistor, capacitor, inductor, potentiometer, transformer, diode, transistor, etc. In addition, the electrical tab 1102 can communicatively couple (e.g., power, transmit an electrical signal, etc.) to other components connected to the flex electrical harness 1100. For example, the electrical tab 1102 can communicate or power components connected to the flex electrical harness 1100 at connection regions 1108 along a flexible circuit body 1106. Alternatively, one or more of the connection regions 1108 along the flexible circuit body 1106 can correspond to a mounting surface that is not necessarily communicatively coupled to the electrical tab 1102.

It will be appreciated that implementing a flexible printed circuit board like the flex electrical harness 1100 can be advantageous for certain purposes. For example, implementing the flex electrical harness 1100 with the frame 700 and the interposer plate 904 can help provide a reduced form factor for an arm of a head-mountable display.

Any of the features, components, and/or parts, including the arrangements and configurations thereof shown in FIG. 11 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 11.

As applicable, data, such as personal information, available from various sources can be used to improve the delivery to users of invitational content or any other content that may be of interest to them. The use of such personal information can be used, in some situations, to improve the user's experience. However, to the extent personal information is used, it should be gathered and implemented according to well-established privacy policies and/or privacy practices. Additionally, in some examples, a user can selectively block the use of, or access to, personal information data.

The specific details provided herein are not required in order to practice the described examples. Therefore, the descriptions of the specific examples described herein are provided for purposes of illustration and description, are not exhaustive, and are note intended to limit the examples to those disclosed herein.

What is claimed is:

1. An arm of a head-mountable display, comprising:
an enclosure comprising a first surface, and a second surface opposing the first surface, the enclosure defining a tip of the arm and an internal volume;
a frame positioned inside the internal volume, the frame comprising a chassis and a hinge connection; and
a printed circuit board (PCB) mounted to the chassis.

2. The arm of the head-mountable display of claim 1, wherein:
the enclosure comprises a seamless enclosure; and
the enclosure defines an assembly access opposite the tip of the arm.

3. The arm of the head-mountable display of claim 2, wherein the frame is insertable into the internal volume through the assembly access.

4. The arm of the head-mountable display of claim 2, wherein the frame is deformable.

5. The arm of the head-mountable display of claim 1, the frame further comprising:
a first material; and
a second material that differs from the first material.

6. The arm of the head-mountable display of claim 5, wherein:
the first material is a plastic material; and
the second material is a metal material.

7. The arm of the head-mountable display of claim 1, wherein the frame comprises a plastic material.

8. The arm of the head-mountable display of claim 1, wherein the frame comprises a metal material.

9. A head-mountable device, comprising:
a display; and
an arm connected to the display, the arm comprising:
an arm housing comprising a uni-body enclosure;
a frame connected to the arm housing at a joint and cantilevered from the joint within the arm housing.

10. The head-mountable device of claim 9, the frame further comprising:
a metal portion; and
a plastic portion.

11. The head-mountable device of claim 10, wherein:
the metal portion comprises titanium; and
the plastic portion comprises a carbon fiber filled nylon.

12. The head-mountable device of claim 10, wherein the joint attaches the metal portion to the arm housing.

13. The head-mountable device of claim 10, wherein the frame comprises a nano-geometry engagement feature at the joint.

14. The head-mountable device of claim 9, further comprising:
an arm hinge connecting the arm to the display; and
a rigid hinge connection defined by the frame and connected to the arm hinge, the rigid hinge connection defining a cable pathway.

15. The head-mountable device of claim 9, wherein the arm further comprises:
at least one of a speaker or a microphone attached to the frame;
a printed circuit board (PCB) mounted to the frame; and
a battery mounted to the frame.

16. An arm subassembly of an augmented reality (AR) glasses arm, comprising:
a chassis defining an opening in a central region of the chassis, the chassis comprising:
a deformable portion;
a rigid portion; and
a hinge integrated with the rigid portion, the hinge defining a cable pathway;
a printed circuit board (PCB) disposed within the opening; and
a cable bundle extending from the PCB and through the cable pathway.

17. The arm subassembly of claim 16, further comprising:
a plate connecting the deformable portion and the rigid portion across the opening; and
a battery attached to the plate.

18. The arm subassembly of claim 16, wherein the rigid portion comprises a backfilled tooling access.

19. The arm subassembly of claim 16, wherein the chassis comprises a curved periphery that covers an edge of the PCB.

20. The arm subassembly of claim 16, wherein:
the deformable portion comprises a first datum;
the rigid portion comprises a second datum; and
the first datum abuts the second datum.
